(19) United States
(12) Patent Application Publication
(10) Pub. No.: US 2024/0356383 A1
(43) Pub. Date: Oct. 24, 2024

(54) CURRENT MODE DEMODULATION FOR NEAR FIELD COMMUNICATION WIRELESS POWER TRANSFER

(71) Applicant: Renesas Electronics America Inc., Milpitas, CA (US)

(72) Inventors: Marco SAUTTO, Zurich (CH); Fabio di FAZIO, Milpitas, CA (US)

(73) Assignee: Renesas Electronics America Inc., Milpitas, CA (US)

(21) Appl. No.: 18/493,013

(22) Filed: Oct. 24, 2023

Related U.S. Application Data
(60) Provisional application No. 63/460,388, filed on Apr. 19, 2023.

(51) Int. Cl. H02J 50/80; H02J 50/10; H04B 5/00

(52) U.S. Cl. CPC H02J 50/80; H02J 50/10; H04B 5/79

(57) ABSTRACT

Systems and methods for demodulation in wireless power transfer systems are described. A circuit a device of a wireless power transfer system can sense current from a switching converter, where the sensed current can be associated with an amplitude shift keying (ASK) signal. The circuit can generate a scaled down current of the sensed current. The circuit can generate a voltage signal using the scaled down current, where the voltage signal can be a scaled down voltage of the ASK signal. The circuit can send the voltage signal to a controller of the device. The controller can demodulate the ASK signal using the scaled down voltage.

### CROSS-REFERENCE TO RELATED APPLICATION

This application claims the benefit of U.S. Provisional Application No. 63/460,388 filed on Apr. 19, 2023. The entire content of U.S. Provisional Application No. 63/460,388 is incorporated herein by reference.

### BACKGROUND

The present disclosure relates in general to apparatuses and methods for demodulation in wireless power devices. Particularly, the demodulation is a current mode demodulation that can be performed by near field communication (NFC) wireless charging devices.

Wireless power transfer using near field communication (NFC) protocol (e.g., NFC wireless power systems) can occur between two devices that include near field communication (NFC) interfaces. Such NFC wireless power systems can include a poller having a transmission coil and a listener having a receiver coil. In an aspect, the poller may be connected to a structure including a wireless charging region. In response to a device including the listener being placed near a device including the poller, the transmission coil and the receiver coil can be inductively coupled with one another to establish an NFC communication link between the poller and the listener and inductive transfer of alternating current (AC) power can occur using the established NFC communication link. The transfer of AC power, from the poller to the listener, can facilitate charging of a battery of the device including the listener.

### SUMMARY

In one embodiment, a semiconductor device for demodulation in wireless power devices is generally described. The semiconductor device can include a controller. The semiconductor device can further include a switching converter and a circuit. The circuit can be configured to sense current in the switching converter. The sensed current can be associated with an amplitude shift keying (ASK) signal. The circuit can be further configured to convert the sensed current from the switching converter into a voltage signal. The voltage signal can be a scaled down voltage of the ASK signal. The circuit can be further configured to output the voltage signal to the controller. The controller can be configured to use the voltage signal to demodulate the ASK signal.

In one embodiment, a semiconductor device for demodulation in wireless power devices is generally described. The semiconductor device can include at least one replica metal-oxide-semiconductor field-effect transistor (MOSFET) that can be a replica of at least one of a first low-side MOSFET and a second low-side MOSFET in a switching converter. The semiconductor device can further include a minimum selector configured to sense current from the switching converter. The sensed current can be associated with an amplitude shift keying (ASK) signal. The minimum selector can be further configured to output a scaled down current of the sensed current. The semiconductor device can further include a current mirror configured to replicate the scaled down current. The semiconductor device can further include an envelope detector configured to use the scaled down current to generate a voltage signal. The voltage signal can be a scaled down voltage of the ASK signal. The envelope detector can be configured to send the scaled down voltage to a controller of the switching converter.

In one embodiment, a method for demodulation in wireless power devices in generally described. The method can include sensing current from a switching converter. The sensed current can be associated with an amplitude shift keying (ASK) signal. The method can further include generating a scaled down current of the sensed current. The method can further include generating a voltage signal using the scaled down current. The voltage signal can be a scaled down voltage of the ASK signal. The method can further include demodulating the ASK signal using the scaled down voltage.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a diagram showing an example system that can implement current mode demodulation for near field communication wireless power transfer in one embodiment.

FIG. 2 is a diagram showing an example circuit that can be implemented in a poller to execute current mode demodulation for near field communication wireless power transfer in poller form in one embodiment.

FIG. 3 is a diagram showing an example circuit that can be implemented in a listener to execute current mode demodulation for near field communication wireless power transfer in listener form in one embodiment.

FIG. 4 is a diagram showing an example circuit that can be implemented in a poller or a listener to execute current mode demodulation for near field communication wireless power transfer in one embodiment.

FIG. 5 is a diagram showing example waveforms of an implementation of current mode demodulation for near field communication wireless power transfer in one embodiment.

FIG. 6 is a flow diagram illustrating a process to implement current mode demodulation for near field communication wireless power transfer in one embodiment.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

NFC wireless power systems can provide charging under a static mode or a negotiated mode. Static mode can use standard radio frequency (RF) field strength and provides a consistent power level and negotiated mode can use a relatively higher RF field supporting different power transfer classes, such as 250, 500, 750 and 1000 milliwatts (mW). In NFC wireless power systems, the poller and listener can communicate with each other using NFC communication protocols. In an aspect, NFC wireless power systems can use a specific base frequency (e.g., 13.56 Megahertz (MHz)) and leverages the NFC communication link between the two devices to control the power transfer. To perform NFC communication, one device can apply or transfer a modulation signal, for example, amplitude-shift keying (ASK) signal, to the other device, and the other device can demodulate the modulation signal.

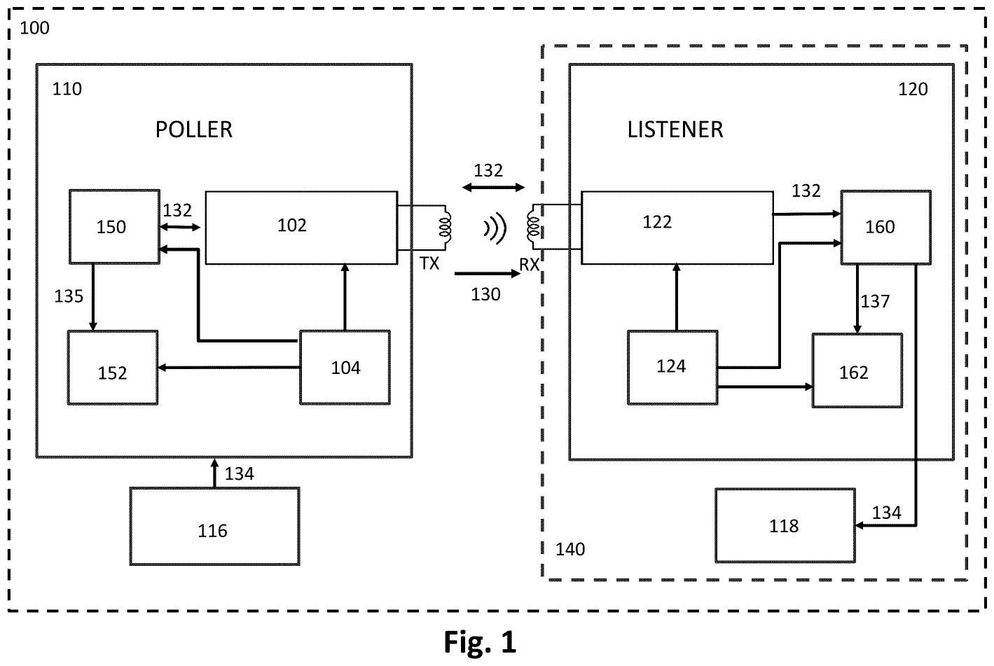

FIG. 1 is a diagram showing an example system that can implement current mode demodulation in NFC in one embodiment. System 100 can include power devices, such as a transmitter 110 and a receiver 120, that are configured to wirelessly transfer power and data therebetween via inductive coupling. While described herein as transmitter 110 and receiver 120, each of transmitter 110 and receiver 120 may be configured to both transmit and receive power or data therebetween via inductive coupling. Transmitter 110 can be referred to as a wireless power transmitter and receiver 120 can be referred to as a wireless power receiver. In an embodiment where system 100 is configured as an NFC wireless power system, transmitter 110 can be configured as a poller and receiver 120 can be configured as a listener.

Transmitter 110 is configured to receive power from one or more power supplies and to transmit AC power to receiver 120 wirelessly. For example, transmitter 110 may be configured for connection to a power supply 116 such as, e.g., an adapter or a DC power supply. Transmitter 110 can be a semiconductor device including a controller 104, a resonant circuit 102, a switching converter 150 and a circuit 152. Switching converter 150 can be an integrated circuit (IC), that can be a part of a power driver, configured to convert one type of electric current into another type of electric current. By way of example, switching converter 150 can be configured as an inverter to convert a DC signal into an AC signal. To be described in more detail below, circuit 152 can be configured to sense current 135 in switching converter 150 and convert the sensed current 135 into scaled down voltages that can be used by controller 104 to demodulate ASK signals.

Controller 104 can be configured to control and operate switching converter 150, circuit 152, and other components of transmitter 110. Controller 104 can include, for example, a processor, central processing unit (CPU), field-programmable gate array (FPGA) or any other circuitry that is configured to control and operate switching converter 150. While described as a CPU in illustrative embodiments, controller 104 is not limited to a CPU in these embodiments and may comprise any other circuitry that is configured to control and operate switching converter 150. In an example embodiment, controller 104 can be configured to control switching converter 150 to drive the resonant circuit 102 to produce a magnetic field. Switching converter 150 can drive coil TX at a range of frequencies and configurations defined by wireless power standards, such as, e.g., the NFC Forum's wireless charging (WLC) specifications. The resonant circuit 102 can include a coil TX and one or more capacitors, inductors, resistors, that can form circuitry for outputting ASK signal 132 and conveying AC power 130 to the receiver 120.

Receiver 120 can be configured to receive AC power 130 transmitted from transmitter 110 and to supply the power to one or more loads 118 or other components of a destination device that includes receiver 120. Load 118 may comprise, for example, a battery charger that is configured to charge a battery of the destination device 140, a DC-DC converter that is configured to supply DC power 134 to a processor, a display, or other electronic components of the destination device 140, or any other load of the destination device 140. A destination device can include receiver 120 and can be, for example, a computing device, smart device, wearable device or any other electronic device that is configured to receive power wirelessly. In other embodiments, receiver 120 may be separated from a destination device and connected to the destination device via a wire or other component that is configured to provide power to destination device 140.

Receiver 120 can be a semiconductor device including a controller 124, a resonant circuit 122, a switching converter 160 and a circuit 162. Controller 124 can be an integrated circuit including, for example, a digital controller such as a microcontroller, a processor, CPU, FPGA or any other circuitry that may be configured to control and operate switching converter 160. Resonant circuit 122 can include a coil RX and one or more capacitors, inductors, resistors, that can form circuitry for outputting ASK signal 132 and conveying AC power 130, received from transmitter 110. Switching converter 160 can be an IC configured to convert one type of electric current into another type of electric current. By way of example, switching converter 160 can be configured as a power rectifier to convert an AC signal into a DC signal. Power switching converter 160, when configured as a power rectifier, can include a rectifier circuit such as half-bridge rectifiers, full bridge rectifiers, or other types of rectifier circuits that can be configured to rectify power received via resonant coil RX of resonant circuit 122 into a power type as needed for load 118. To be described in more detail below, circuit 162 can be configured to sense current 137 in switching converter 160 and convert the sensed current 137 into scaled down voltages that can be used by controller 124 to demodulate ASK signals. Controller 124 can be configured to execute application specific programs and/or firmware to control and operate various components, such as resonant circuit 122 and switching converter 160, of receiver 120.

As an example, when receiver 120 is placed in proximity to transmitter 110, the magnetic field produced by coil TX of resonant circuit 102 and switching converter 150 induces a current in coil RX of resonant circuit 122. The induced current causes AC power 130 to be inductively transmitted to switching converter 160, via resonant circuit 122. Switching converter 160 receives AC power 130 and converts AC power 130 into DC power 134. DC power 134 is then provided to load 118.

Transmitter 110 and receiver 120 are also configured to exchange information or data, e.g., messages, via the inductive coupling of power driver 106 and resonant circuit 102 and 122. For example, before transmitter 110 begins transferring power to receiver 120, a power contract may be agreed upon and created between receiver 120 and transmitter 110. For example, receiver 120 may send ASK signals 132 or other data to transmitter 110 that indicate power transfer information such as, e.g., an amount of power to be transferred to receiver 120, commands to increase, decrease, or maintain a power level of AC power 130, commands to stop a power transfer, or other power transfer information. In another example, in response to receiver 120 being brought in proximity to transmitter 110, e.g., close enough such that a transformer may be formed by coil TX and coil RX to allow power transfer, receiver 120 may be configured to initiate communication by sending a signal to transmitter 110 that requests a power transfer. In such a case, transmitter 110 may respond to the request by receiver 120 by establishing the power contract or beginning power transfer to receiver 120, e.g., if the power contract is already in place. Transmitter 110 and receiver 120 may transmit and receive ASK signal 132, data or other information via the inductive coupling of coil TX and coil RX.

In conventional NFC wireless power systems, the poller and listener can demodulate ASK signals using voltage mode demodulation that includes sensing the differential voltage on the antenna or coil. However, the voltage across the antenna can be relatively high, such as at least 50 volts (V), and external components (e.g., capacitive divider) may be needed to step down the voltage level in order for the poller or listener to sense or measure the voltage across the antenna. The external components can increase build of materials (BOM) and cost.

To perform ASK demodulation without additional external components, system 100 can be configured to perform current mode demodulation of ASK signals. Circuit 152 in transmitter 110 be configured to sense current 135 flowing in switching converter 150 and convert the sensed current into scaled down voltages that can be read by controller 104 to demodulate ASK signals. Circuit 162 in receiver 120 be configured to sense current 137 flowing in power switching converter 160 and convert the sensed current into voltages that can be read by controller 124 to demodulate ASK signals.

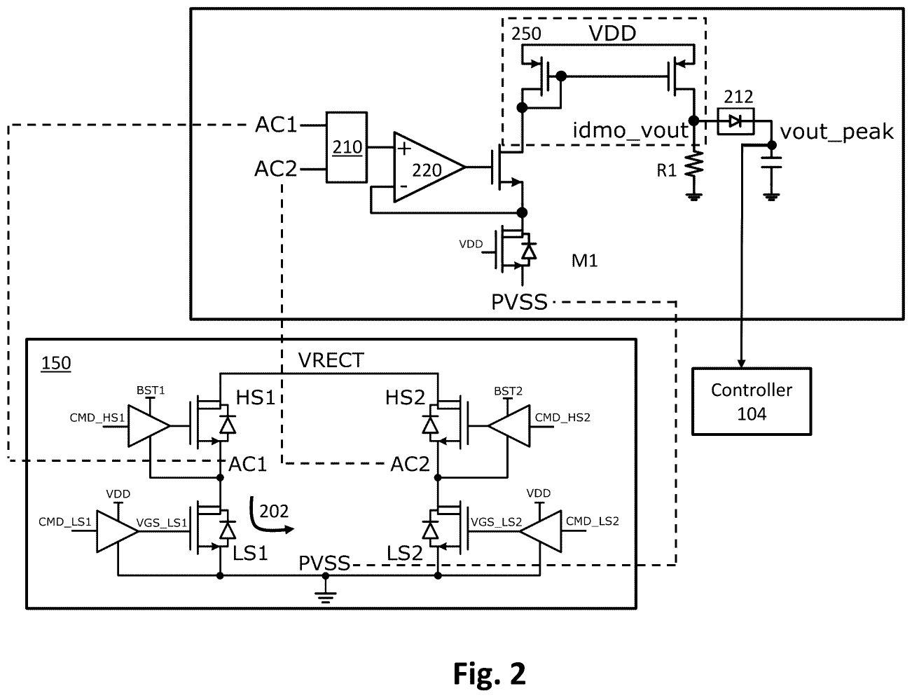

FIG. 2 is a diagram showing an example circuit that can be implemented in a poller to execute current mode demodulation for near field communication wireless power transfer in poller form in one embodiment. Descriptions of FIG. 2 may reference components shown in FIG. 1. In an embodiment shown in FIG. 2, switching converter 150 can be formed by two half-bridge circuits including two high-side metal-oxide-semiconductor field-effect transistors (MOSFETs) HS1, HS2 and two low-side MOSFETs LS1, LS2. Circuit 152 can be configured to sense current 135 in switching converter 150 and convert the sensed current 135 into scaled down voltages that can be used by controller 104 to demodulate ASK signals. In one embodiment, circuit 152 can be connected to switching converter 150 at nodes AC1 and AC2. Circuit 152 can include a minimum selector 210 configured to select the smaller or minimum voltage between AC1 and AC2. The output of the minimum selector 210 can be provided as an input to the positive input (e.g., non-inverting input) of an operational amplifier 220 of circuit 152 while the negative input (e.g., inverting input) is connected to a MOSFET M1. MOSFET M1 can be a replica of LS1 and/or LS2 that can mirror the current in AC1 and AC2 when given the same Vds (drain-source voltage) and Vgs (gate-source voltage) as the corresponding low side (LS). Circuit 152 can further include an envelope detector or a peak detector 212 to detect the envelope of the ASK signal 132.

To demodulate the ASK signal 132, the resonant circuit 122 in receiver 120 can pass the ASK signal 132 to switching converter 150 in transmitter 110. When switching converter 150 is in listening mode, i.e., receiving ASK signal 132, a current 202 (which can be current 135 in FIG. 1) can flow from VRECT to PVSS. As the current 202 flows through switching converter 150, the switches at LS1 and LS2 can alternatively switch on and off. During one half of a cycle of carrier signal 130, LS1 turns on. When LS1 turns on, the current 202 can flow through LS1 and the voltage at AC1 will go low while the voltage at AC2 will be high. During the other half of a duty cycle of carrier signal 130, LS2 turns on and LS1 turns off. When LS2 turns on, the current 202 can flow through LS2 and AC2 will go low while AC1 will be high.

Transmitter 110 can be configured to demodulate ASK signals transmitted by the receiver 120. When a gate-source voltage Vgs and a drain-source voltage Vds of LS1 and LS2 are applied on the replica MOSFET M1, a scaled down version of the current 202 flowing through the switching converter 150, more specifically, at AC1 and AC2 is copied. A minimum selector 210 can be connected to the AC1 and AC2 switch nodes of switching converter 150. Minimum selector 210 can allow circuit 152 to continuously track the current 202 flowing through AC1 and AC2 by copying voltages at AC1 and AC2 while the LS1 and LS2 continuously and alternatively switch on and off. Using the minimum selector 210, the circuit 152 can copy a scaled down version of current 202 at AC1 or AC2 that corresponds to the switch LS1 or LS2 that is on.

In one embodiment, MOSFET M1 can be a scaled down version (e.g., smaller in size) of MOSFETs LS1 and/or LS2. The utilization of a replica that is smaller than MOSFETs LS1 and/or LS2 can allow transmitter 110 to perform the current demodulation described herein with the addition of a relatively small circuit (e.g., circuit 152). Further, the smaller replica M1 can provide scaled down current to lower the power consumption of the circuit. By pushing the current on a resistance R1 a scaled down voltage is provided to controller 104 such that controller 104 can perform demodulation using the scaled down voltage without external components such as capacitive dividers for stepping down the voltage of the received ASK signal.

After circuit 152 receives the copied, scaled down current, the scaled down current can be provided to a current mirror 250. Current mirror 250 can copy the scaled down current, and a resistor R1 can push the scaled down current towards a peak detector 212 such that peak detector 212 receives an AC signal idmo_vout as an input. Peak detector 212 can be configured to detect and output an envelope of the AC signal idmo_vout as an output voltage Vout_peak. The output voltage Vout_peak can be a scaled down voltage of the received ASK signal 132. Circuit 152 can output vout_peak to controller 104 and controller 104 can perform demodulation on vout_peak to demodulate a message or data encoded in ASK signal 132.

In one or more embodiments, circuit 152 can be connected to other points or components of switching converter 150 to sense current 202. In one embodiment, replica M1 in circuit 152 can be connected to a node between HS1 and VRECT and a node between HS2 and VRECT to sense current flowing through HS1 or HS2. Note that using current sensed from HS1 and HS2 can result in bigger circuits due to the need of interfacing with high voltage VRECT when compared to embodiments where current is sensed from LS1 and LS2. In another embodiment, current sensors, such as sense resistors, can be connected in various locations in switching converter 150 and circuit 152 can use current measured by these current sensors. The locations to measure the current in switching converter 150 can be dependent on a desired implementation of transmitter 110.

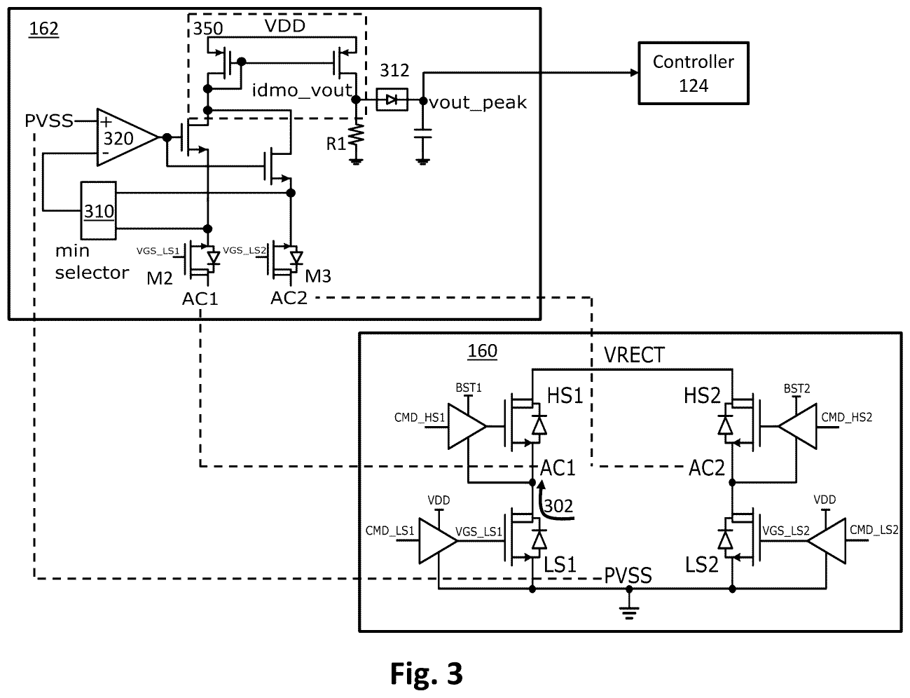

FIG. 3 is a diagram showing an example circuit that can be implemented in a listener to execute current mode demodulation for near field communication wireless power transfer in listener form in one embodiment. Descriptions of FIG. 3 may reference components shown in FIG. 1 to FIG. 2. In an embodiment shown in FIG. 3, switching converter 160 can be made up of two half-bridge circuits comprising of two high-side MOSFETs and two low-side MOSFETs HS1, HS2, LS1, LS2. Circuit 162 can be configured to sense current 302 (which can be current 137 in FIG. 1) in switching converter 160 and convert the sensed current 302 into scaled down voltages that can be used by controller 124 to demodulate ASK signals. In one embodiment, circuit 162 can be connected to switching converter 160 at AC1 and AC2. Circuit 162 can also include a minimum selector 310 configured to select the minimum voltage between switch nodes AC1 and AC2. The output of the minimum selector 310 can be inputted to the negative input of an operational amplifier 320 of circuit 162 while the positive input is connected to PVSS. M2 and M3 are configured to be replica MOSFETs that can mirror the current 302 in AC1 and AC2 when given the same Vds and Vgs as switching converter 160. Circuit 162 can further include an envelope detector or a peak detector 312 to detect the envelope of the ASK signal 132.

Circuit 162 can be configured to use replica MOSFETs M1 and M2. When a gate-source voltage Vgs and a drain-source voltage Vds of LS1 and LS2 are applied on the replica MOSFETs M1 and M2, scaled down versions of the current 302 flowing through the switching converter 160, more specifically, at AC1 and AC2 are copied. Minimum selector 310 can be connected to the AC1 and AC2 points at the replica MOSFETs M1 and M2. Minimum selector 310 can allow circuit 162 to continuously track the current 302 flowing through switch nodes AC1 and AC2 by copying voltages at AC1 and AC2 while the LS1 and LS2 continuously and alternatively switch on and off. Using the minimum selector, the circuit 162 can copy scaled down versions of current 302 at AC1 or AC2 that corresponds to the switch LS1 or LS2 that is on.

In one embodiment, MOSFETs M2 and M3 can be scaled down versions (e.g., smaller in size) of MOSFETs LS1 and LS2, respectively. The utilization of replicas that are smaller than MOSFETs LS1 and LS2 can allow receiver 120 to perform the current demodulation described herein with the addition of a relatively small circuit (e.g., circuit 162). Further, the smaller replicas M2 and M3 can provide scaled down current to lower the power consumption of the circuit. By pushing the current on a resistance R1, a scaled down voltage is provided to controller 104 such that controller 104 can perform demodulation using the scaled down voltage without external components such as capacitive dividers for stepping down the voltage of the received ASK signal.

After circuit 162 receives the copied, scaled down current, the scaled down current can be provided to a current mirror 350. Current mirror 350 can copy the scaled down current, and a resistor R1 can push the scaled down current towards a peak detector 312 such that peak detector 312 receives an AC signal idmo_vout as an input. Peak detector 312 can be configured to detect and output an envelope of the AC signal idmo_vout as an output voltage vout_peak. The output voltage vout_peak can be a scaled down voltage of the received ASK signal 132. Circuit 162 can output vout_peak to controller 124 and controller 124 can perform demodulation on vout_peak to demodulate a message or data encoded in ASK signal 132.

In one or more embodiments, circuit 162 can be connected to other points or components of switching converter 160 to sense current 302. In one embodiment, replicas M2 and M3 in circuit 162 can be connected to nodes between HS1 and VRECT and between HS2 and VRECT to sense current flowing through HS1 or HS2. Note that using current sensed from HS1 and HS2 can result in bigger circuits due to the need of interfacing with high voltage VRECT when compared to embodiments where current is sensed from LS1 and LS2. In another embodiment, current sensors, such as sense resistors, can be connected in various locations in switching converter 160 and circuit 162 can use current measured by these current sensors. The locations to measure the current in switching converter 160 can be dependent on a desired implementation of receiver 120.

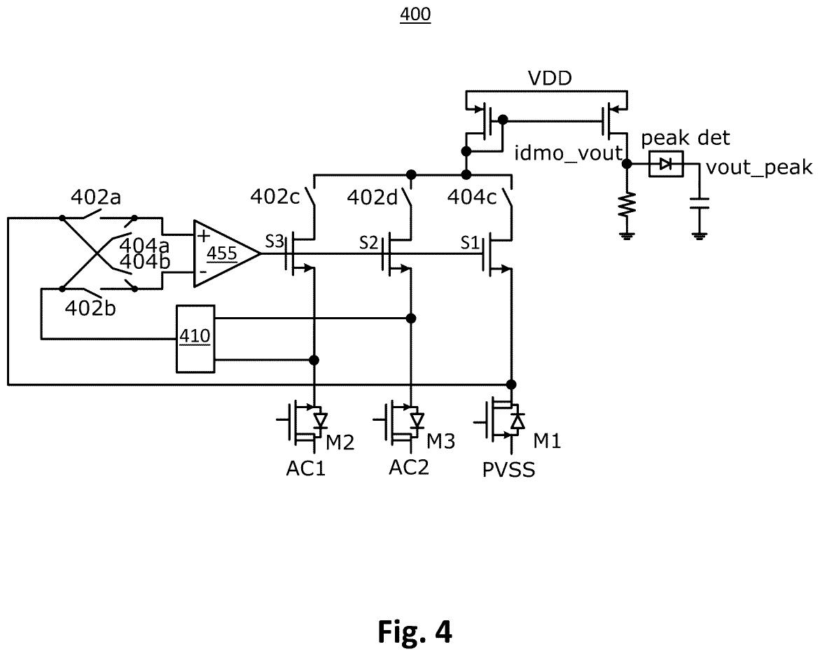

FIG. 4 is a diagram showing an example circuit that can be implemented in a poller or a listener to execute current mode demodulation for near field communication wireless power transfer in one embodiment. Descriptions of FIG. 4 may reference components shown in FIG. 1 to FIG. 3. A circuit 400 shown in FIG. 4 can be an IC that can be configured to operate as circuit 152 and/or 162. Circuit 400 can be implemented in both a poller and a listener of a NFC power transfer system based on states of a plurality of switches and replicas M1, M2, M3 shown in FIG. 4.

In one embodiment, M1, M2, M3 can be FETs that can function as replica FETs and as switches. When one or more of replicas M1, M2, M3 are configured to be replica FETs, circuit 400 can copy Vds and Vgs of the replica FET that can be used for the demodulation schemes described herein. If circuit 400 is implemented in a poller, then circuit 400 can be configured or programmed to operate as circuit 152. In one embodiment, controller 104 of transmitter 110 can turn on or close switches 404a, 404b, 404c, turn off or open switches 402a, 402b, 402c, 402d, and turn on FETs M2 and M3. By way of example, in response to turning on M2, M3 as ON switches, AC1 and AC2 can be connected to a shared minimum selector 410. Also, in response to closing switches 404a, 404b and opening switches 402a, 402b, PVSS and an output of minimum selector 410 can be provided to an operational amplifier 455. Further, in response to closing switch 404c, an output of operational amplifier 455 can turn on a FET S1 to connect FET M1 to current mirror 450. Current mirror 450 can be identical to current mirror 250 in FIG. 2 and current mirror 350 in FIG. 3.

If circuit 400 is implemented in a listener, then circuit 400 can be configured or programmed to operate as circuit 162. In one embodiment, controller 104 of transmitter 110 can turn on or close switches 402a, 402b, 402c, 402d, turn off or open switches 404a, 404b, 404c, and turn on FET M1. By way of example, in response to turning on M1 as an ON switch and closing switch 402a, PVSS can be provided as an input to operational amplifier 455. AC1 and AC2 can also be provided to minimum selector 410 and the output of minimum selector 410 can be provided to operational amplifier 455 via the closed switch 402b. Further, in response to closing switches 402c. 402d, an output of operational amplifier 455 can turn on FETs S2, S3 to connect FETs M2, M3 to current mirror 450.

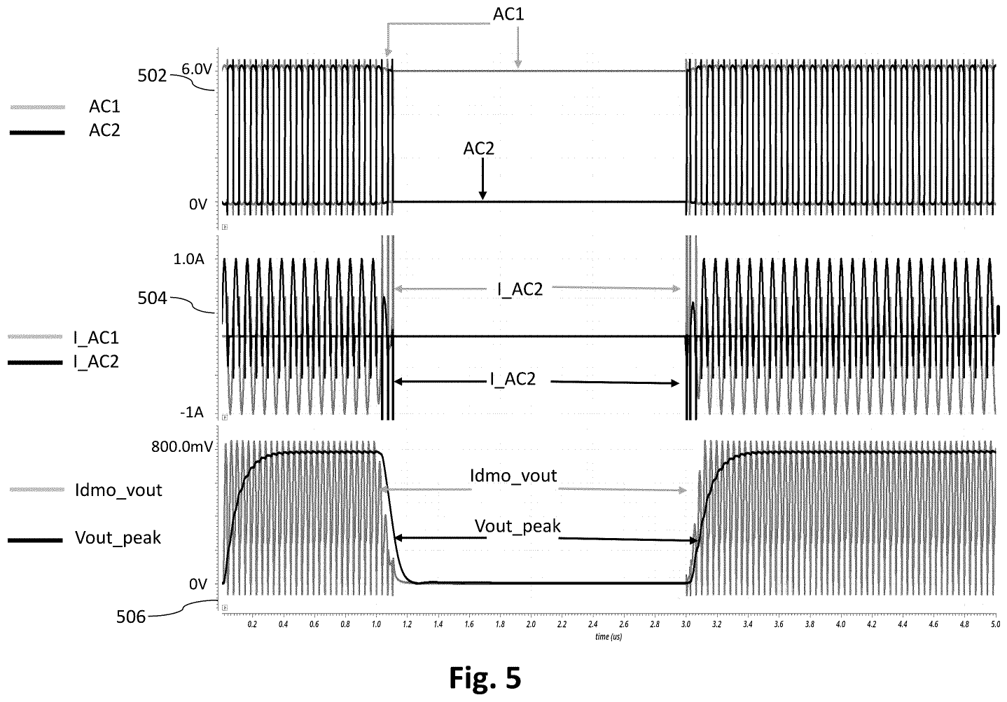

FIG. 5 is a diagram showing example waveforms of an implementation of current mode demodulation for near field communication wireless power transfer in one embodiment. The waveforms in FIG. 5 show an example of the modulation and demodulation of AC signal at 100%. Waveforms 502 is an example of modulation signal as seen on the voltage of AC1 and AC2. Waveforms 504 is an example of the plotted current that flows through AC1 and AC2. Waveforms 506 is an example of the envelope that can be found when demodulation the AC signal. Idmo_vout is the output current from the current mirrors 250, 350, 450 and can be a scaled down, proportional version of the sensed currents from switch nodes AC1 and AC2. Vout_peak is the scaled down voltage outputted by the peak detectors 212, 312. Note that in waveforms 502, the voltage levels at AC1, AC2 varies from approximately 0V to approximately 6.0V, and in waveforms 506, the scaled down voltages varies from approximately 0V to 800.0 millivolts (mV). The scaled down voltages as shown in waveforms 506 can allow transmitter 110 and/or receiver 120 to demodulate ASK signals without external components to step down the ASK signal voltages. Note that the same technique can be applied to modulation depth less than 100%, in which case the minimum Vout_peak voltage will not reach 0V.

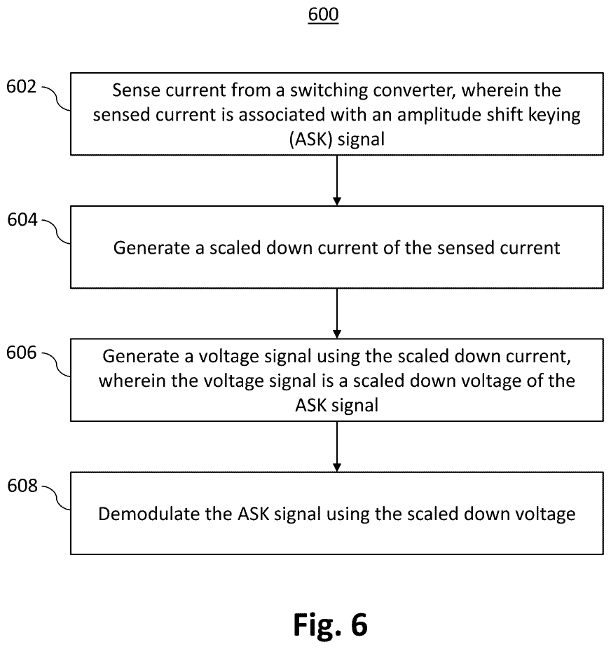

FIG. 6 is a flow diagram illustrating a process to implement current mode demodulation for near field communication wireless power transfer in one embodiment. The process can include one or more operations, actions, or functions as illustrated by one or more of blocks 602, 604, 606 and/or 608. Although illustrated as discrete blocks, various blocks can be divided into additional blocks, combined into fewer blocks, eliminated, performed in different order, or performed in parallel, depending on the desired implementation.

Process 600 can be implemented by a wireless power transfer device (e.g., transmitter, receiver, or transceiver). Process 600 can begin at block 602, where a circuit in a wireless power transfer device can sense current from a switching converter. The sensed current can be associated with an amplitude shift keying (ASK) signal. In one embodiment, the circuit can sense current from a switching converter in a poller of a near field communication (NFC) power transfer system. In one embodiment, the circuit can sense current from a switching converter in a listener of a near field communication (NFC) power transfer system. In one embodiment, the circuit can sense the current by copying the sensed current from a switch node of the switching converter. The switch node can correspond to a low-side metal-oxide-semiconductor field-effect transistor (MOSFET) that is turned on in the switching converter.

The process 600 can continue from block 602 to block 604. At block 604, the circuit can generate a scaled down current of the sensed current. In one embodiment, the circuit can sense current from a switching converter in a poller of a near field communication (NFC) power transfer system, and can use a replica MOSFET to scale down the sensed current. In one embodiment, the circuit can sense current from a switching converter in a listener of a near field communication (NFC) power transfer system, and can use a first replica MOSFET and a second replica MOSFET to scale down the sensed current.

The process 600 can continue from block 604 to block 606. At block 606, the circuit can generate a voltage signal using the scaled down current, where the voltage signal can be a scaled down voltage of the ASK signal. In one embodiment, the circuit can generate the voltage signal by detecting an envelope of the scaled down current to generate the scaled down voltage. The process 600 can continue from block 606 to block 608. At block 608, a controller of the wireless power transfer device can demodulate the ASK signal using the scaled down voltage.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A semiconductor device comprising:
a controller;
a switching converter; and
a circuit configured to:
sense current in the switching converter, wherein the sensed current is associated with an amplitude shift keying (ASK) signal;
convert the sensed current from the switching converter into a voltage signal, wherein the voltage signal is a scaled down voltage of the ASK signal; and
output the voltage signal to the controller,
wherein the controller is configured to use the voltage signal to demodulate the ASK signal.

2. The semiconductor device of claim 1, wherein the switching converter is in a poller of a near field communication (NFC) power transfer system.

3. The semiconductor device of claim 1, wherein the switching converter is in a listener of an NFC power transfer system.

4. The semiconductor device of claim 1, wherein the circuit comprises:
at least one replica metal-oxide-semiconductor field-effect transistor (MOSFET) configured to scale down the sensed current;
a minimum selector configured to copy a voltage of the sensed current from a switch node of the switching converter, wherein the switch node corresponds to a low-side MOSFET that is turned on in the switching converter;
a current mirror configured to replicate the scaled down current; and
an envelope detector configured to generate the scaled down voltage based on the scaled down current.

5. The semiconductor device of claim 4, wherein the at least one replica MOSFET is smaller than a first low-side MOSFET and a second low-side MOSFET in the switching converter.

6. The semiconductor device of claim 1, wherein:
the switching converter is in a poller of an NFC power transfer system; and
the circuit comprises a replica MOSFET;
the replica MOSFET is a replica of at least one of a first low-side MOSFET and a second low-side MOSFET in the switching converter; and
the sensed current is sensed from a switch node connected to one of the first low-side MOSFET and the second low-side MOSFET that is turned on.

7. The semiconductor device of claim 1, wherein:
the switching converter is in a listener of an NFC power transfer system; and
the circuit comprises:
a first replica MOSFET that is a replica of a first low-side MOSFET in the switching converter;
a second replica MOSFET that is a replica of a second low-side MOSFET in the switching converter; and
the sensed current is sensed from one of a first switch node connected to the first low-side MOSFET and a second switch node connected to the second low-side MOSFET.

8. A semiconductor device comprising:
at least one replica metal-oxide-semiconductor field-effect transistor (MOSFET) that is a replica of at least one of a first low-side MOSFET and a second low-side MOSFET in a switching converter;
a minimum selector configured to:
copy a voltage from a switch node in the switching converter, wherein the copied voltage is associated with an amplitude shift keying (ASK) signal; and
cause a scaled down current to be sensed from the at least one replica;
a current mirror configured to replicate the scaled down current; and
an envelope detector configured to:
use the scaled down current to generate a voltage signal, wherein the voltage signal is a scaled down voltage of the of the voltage associated with the ASK signal; and
send the scaled down voltage to a controller of the switching converter.

9. The semiconductor device of claim 8, wherein the switching converter is in a poller of a near field communication (NFC) power transfer system.

10. The semiconductor device of claim 8, wherein the switching converter is in a listener of an NFC power transfer system.

11. The semiconductor device of claim 8, further comprising a plurality of switches, wherein:
the switching converter is in a poller of an NFC power transfer system; and
in response to the switching converter being in the poller of the NFC power transfer system, operate a subset of the plurality of switches to connect a replica MOSFET the minimum selector and the current mirror.

12. The semiconductor device of claim 8, further comprising a plurality of switches, wherein:
the switching converter is in a listener of an NFC power transfer system; and
in response to the switching converter being in the listener of the NFC power transfer system, operate a subset of the plurality of switches to:
connect a first replica MOSFET to the minimum selector and the current mirror, wherein the first replica MOSFET is a replica of the first low-side MOSFET; and
connect a second replica MOSFET to the minimum selector and the current mirror, wherein the second replica MOSFET is a replica of the second low-side MOSFET.

13. The semiconductor device of claim 8, wherein the at least one replica MOSFET is smaller than the first low-side MOSFET and the second low-side MOSFET in the switching converter.

14. A method comprising:
sensing current from a switching converter, wherein the sensed current is associated with an amplitude shift keying (ASK) signal;
generating a scaled down current of the sensed current;
generating a voltage signal using the scaled down current, wherein the voltage signal is a scaled down voltage of the ASK signal; and
demodulating the ASK signal using the scaled down voltage.

15. The method of claim 14, wherein sensing current from the switching converter comprises sensing current from a switching converter in a poller of a near field communication (NFC) power transfer system.

16. The method of claim 14, wherein sensing current from the switching converter comprises sensing current from a switching converter in a listener of a near field communication (NFC) power transfer system.

17. The method of claim 14, wherein sensing current from the switching converter comprises copying the sensed current from a switch node of the switching converter, wherein the switch node corresponds to a low-side metal-oxide-semiconductor field-effect transistor (MOSFET) that is turned on in the switching converter.

18. The method of claim 14, wherein generating the voltage signal comprises detecting an envelope of the scaled down current to generate the scaled down voltage.

19. The method of claim 14, wherein:
sensing current from the switching converter comprises sensing current from a switching converter in a poller of a near field communication (NFC) power transfer system; and
the method further comprising using a replica MOSFET to scale down the sensed current.

20. The method of claim 14, wherein:
sensing current from the switching converter comprises sensing current from a switching converter in a listener of a near field communication (NFC) power transfer system; and
the method further comprising using a first replica MOSFET and a second replica MOSFET to scale down the sensed current.
